(19) United States
(12) Patent Application Publication
(10) Pub. No.: US 2026/0161162 A1
(43) Pub. Date: Jun. 11, 2026

(54) Removable In-Vehicle Control Unit

(71) Applicant: Nissan North America, Inc., Franklin, TN (US)

(72) Inventors: Liam Pedersen, San Francisco, CA (US); Thiago Aguiar, San Jose, CA (US); Tomoki Eto, Santa Clara, CA (US); Pratham Oza, San Jose, CA (US); Viju James, Fremont, CA (US); Fang-Chieh Chou, Santa Clara, CA (US); Zvi Guter, Bronx, NY (US)

(21) Appl. No.: 18/977,267

(22) Filed: Dec. 11, 2024

(51) Int. Cl. G05D 1/222; B60R 11/00

(52) U.S. Cl. CPC G05D 1/222; B60R 11/00; B60R 2011/0005

(57) ABSTRACT

In some embodiments, an apparatus for facilitating control of a vehicle includes a sensor component configured to be removably attached to a dashboard of the vehicle. The sensor component comprises a body having a front end and an opposite rear end, an attachment mechanism extending from the front end configured to temporarily attach the sensor component to the dashboard, and a release mechanism extending from the rear end and operatively coupled to the attachment mechanism. The release mechanism is configured to facilitate causing the attachment mechanism to detach from the dashboard. The attachment mechanism may include an alignment feature configured to align the sensor component with a dashboard feature of the vehicle. The apparatus may further include an electronics component communicatively coupled to the sensor component.

### TECHNICAL FIELD

The present disclosure relates to vehicle control systems, and more particularly to systems and methods for autonomously controlling finished vehicles within a controlled roadway region.

### BACKGROUND

In the automotive industry, finished vehicles, which are at least partially assembled and ready for sale or distribution, undergo several stages of handling after leaving the assembly line. These stages typically include quality control checks, temporary storage, and transportation to various distribution points. The movement of finished vehicles within a controlled environment, such as a manufacturing facility or distribution center, involves coordinating the transfer of vehicles between different areas such as testing facilities, storage lots, and loading zones for rail or truck transport.

### SUMMARY

According to an aspect of the present disclosure, an apparatus for facilitating control of a vehicle is provided. The apparatus includes a sensor component configured to be removably attached to a dashboard of the vehicle. The sensor component includes a body having a front end and an opposite rear end. The sensor component also includes an attachment mechanism extending from the front end, wherein the attachment mechanism is configured to temporarily attach the sensor component to the dashboard. The sensor component further includes a release mechanism extending from the rear end and operatively coupled to the attachment mechanism, wherein the release mechanism is configured to facilitate causing the attachment mechanism to detach from the dashboard.

According to another aspect of the present disclosure, an In-Vehicle Controller Unit (ICU) for controlling a vehicle is provided. The ICU includes a sensor component configured to be removably attached to a dashboard of the vehicle, the sensor component comprising at least one sensor. The ICU also includes a communication component comprising a transceiver configured to facilitate wireless communication with a wireless network node associated with a remote operation system. The ICU further includes a connection assembly configured to communicably couple the ICU with a control area network (CAN) of the vehicle.

According to another aspect of the present disclosure, a method of controlling a vehicle on a roadway is provided. The method includes providing a remote operation system located outside of the vehicle, the remote operation system configured to determine driving operations for controlling the vehicle. The method also includes providing a removable In-Vehicle Controller Unit (ICU) for temporary installation in the vehicle, the ICU including a sensor component having a body and an attachment mechanism extending from a front side of the body, the attachment mechanism comprising an alignment feature configured to align the sensor component with a dashboard feature of the vehicle. The method further includes generating, using the remote operation system, driving instructions for controlling the vehicle to traverse at least a portion of the roadway. The method also includes transmitting a control signal to the ICU, the control signal indicative of the driving instructions.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device capable of performing functions described later herein.

FIG. 4 illustrates an example of a controlled roadway region, in accordance with the present disclosure.

FIG. 5 is a flow diagram illustrating an example of a process for controlling a finished vehicle in a controlled roadway region, in accordance with the present disclosure.

FIG. 6 is a schematic diagram showing an operating environment within which aspects of the system and apparatuses described herein may be implemented.

FIG. 7 is a diagram of an example of a vehicle having an ICU temporarily installed therein, in accordance with the present disclosure.

FIGS. 8A-8F are diagrams illustrating an example of an ICU, in accordance with the present disclosure.

FIG. 9 is a diagram illustrating another example of an ICU, in accordance with the present disclosure.

### DETAILED DESCRIPTION

In various industries and applications, there may be a need to temporarily make vehicles autonomous for specific purposes or within controlled environments. This need can arise in diverse scenarios, from manufacturing and logistics to testing and specialized operations. For example, in the automotive industry, the logistics of managing finished vehicles from the assembly line to distribution points may present challenges. These challenges can be particularly noticeable in the final stages of production, where vehicles may need to be moved through various checkpoints, testing areas, and storage facilities before reaching their final distribution channels. Traditional methods of managing this process often rely on human drivers, which in some cases can lead to inefficiencies, increased costs, and potential safety considerations within controlled environments.

The complexity of coordinating multiple vehicles simultaneously, each at different stages of a process, can pose challenges in various contexts. In some scenarios, operators may need to navigate intricate facility layouts, adhere to specific protocols, and ensure timely movement of vehicles, all while minimizing the risk of damage to assets. Manual approaches may be labor-intensive and potentially prone to human error, which in some cases could result in delays, incidents, or misrouting of vehicles.

Furthermore, increasing demands for customization and just-in-time operations in various sectors may amplify the need for more flexible and responsive logistics systems. Some challenges may lie in developing solutions that can autonomously manage the movement of vehicles with precision and efficiency, while also being adaptable to changes in schedules, facility layouts, and operational requirements. Such systems may benefit from capabilities like real-time decision-making, integration with existing processes, and the ability to handle exceptions without compromising overall operational flow. These considerations can apply to various scenarios where temporary vehicle autonomy is desired, including but not limited to automotive manufacturing, warehouse operations, port logistics, and temporary fleet management for events or specialized applications.

Implementations of this disclosure address problems such as these by providing a removable In-Vehicle Controller Unit (ICU) that may be temporarily installed in a vehicle to enable autonomous or remote-controlled operation of the vehicle within a controlled roadway region. The term “controlled roadway region” may include a defined area within which a majority of the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. Another example of a controlled roadway region may include an airport, in which vehicles may be used to facilitate providing services to aircraft, maintenance, and/or the like. Controlled roadway regions may be implemented in any number of different scenarios, all of which are considered to be within the ambit of the present disclosure.

In controlled roadway environments, implementations may include a vehicle logistics autonomy (VLA) system located outside of a vehicle and configured to determine driving operations for controlling the vehicle. The VLA system may generate driving instructions for controlling the vehicle to traverse a transportation network of a controlled roadway region. The ICU may be temporarily installed in the vehicle and may include at least one sensor. The VLA system may transmit a control signal to the ICU, where the control signal is indicative of the driving instructions.

Implementations of this disclosure may enable the ICU to receive additional instructions from a tele-operation device to control the vehicle. This capability allows for human intervention when necessary, providing a flexible system that can adapt to unexpected situations or complex scenarios that may arise. The VLA system may also determine an occurrence of an operation issue with the vehicle and communicate an indication of the operation issue to the tele-operation device, facilitating rapid response to potential problems and maintaining efficient operations within the controlled roadway region.

The ICU may include a sensor component configured to be removably attached to a dashboard of the vehicle. The sensor component may comprise a body having a front end and an opposite rear end, an attachment mechanism extending from the front end configured to temporarily attach the sensor component to the dashboard, and a release mechanism extending from the rear end and operatively coupled to the attachment mechanism. The release mechanism may be configured to facilitate causing the attachment mechanism to detach from the dashboard. As used herein, the term “sensor” refers to any device capable of detecting and responding to input from the physical environment. Examples of sensors may include, but are not limited to, cameras, lidar sensors, radar sensors, ultrasonic sensors, infrared sensors, and motion sensors.

Implementations of this disclosure may further include an attachment mechanism comprising an alignment feature configured to align the sensor component with a dashboard feature of the vehicle. The dashboard feature may comprise at least one of a contour of the dashboard, a speaker cover coupled to the dashboard, or a vent defined in the dashboard. In some implementations, the alignment feature may comprise at least one protrusion extending away from a lower surface of the attachment mechanism, the at least one protrusion having a shape configured such that the at least one protrusion fits into at least one vent defined in the dashboard.

The attachment mechanism may also comprise an upper engagement member, a lower engagement member, and a spring-loaded tension mechanism configured to cause the upper engagement member to engage an inner surface of a windshield of the vehicle and the lower engagement member to engage an upper surface of the dashboard of the vehicle. This configuration allows a tension to be applied between the upper engagement member and the lower engagement member, causing the sensor component to be removably attached between the dashboard and the windshield. As used herein, the term “engagement member” refers to a component designed to make contact with and secure against a surface of the vehicle interior, such as the dashboard or windshield. Alternative implementations may include magnetic attachment mechanisms, suction-based systems, or adjustable clamping mechanisms to accommodate various vehicle interior designs.

A controlled roadway region, as defined in this disclosure, differs significantly from a typical roadway region in a number of aspects. In a controlled roadway region, a single entity has authority over the majority of traffic, allowing for a more structured and predictable environment. This level of control enables the implementation of specialized systems and protocols that may not be feasible in typical roadway regions where traffic is more diverse and less regulated.

One of the primary differences is the ability to implement comprehensive sensor networks and infrastructure components throughout the controlled roadway region. These systems may include cameras, light detection and ranging (LIDAR) sensors, and other monitoring devices that provide real-time data about vehicle positions, speeds, and/or environmental conditions. In contrast, typical roadway regions may have limited sensor coverage, relying more heavily on individual vehicle sensors and sporadic traffic monitoring systems.

The controlled nature of the roadway region also allows for the implementation of standardized communication protocols between vehicles and infrastructure. This may include dedicated short-range communication (DSRC) systems or cellular vehicle-to-everything (C-V2X) technologies that enable seamless information exchange. Such comprehensive communication networks are often not feasible in typical roadway regions due to the diverse range of vehicles and the challenges of retrofitting existing infrastructure.

Implementations of the VLA system described herein take advantage of these differences by utilizing the controlled environment to create a more efficient and predictable system for managing vehicles. The VLA system can leverage the comprehensive sensor data and communication networks to maintain an accurate and up-to-date world model of the entire controlled roadway region. This allows for more precise planning and coordination of vehicle movements, reducing the likelihood of conflicts or inefficiencies that might occur in less controlled environments.

Furthermore, short, established routes that vehicles may take within a controlled roadway region can present unique opportunities for optimization. Unlike typical automated vehicles that may need to navigate complex and unpredictable city streets or highways, vehicles in a controlled roadway region may follow predetermined paths between known points of interest, such as assembly lines, testing areas, and distribution centers. This may allow the VLA system to create highly optimized trajectories and schedules, taking into account factors such as production timing, vehicle specifications, and distribution requirements.

The controlled environment also enables the use of removable ICUs in vehicles. These ICUs can be designed specifically for the controlled roadway region, focusing on the limited set of maneuvers and routes required within the facility. This contrasts with the more complex autonomous driving systems needed for typical automated vehicles that must handle a wide range of driving scenarios and environments. The removable ICUs may be more cost-effective and easier to install and remove, facilitating the efficient movement of vehicles through logistics processes.

According to some implementations, a VLA system (which may be implemented as one or more physical machines and/or virtual machines) accesses infrastructure data from sensors of an infrastructure associated with a roadway portion of the controlled roadway region. The sensors may include any number of different types of roadway sensors. The infrastructure data may include a position of a vehicle, a velocity of a vehicle, and/or a following distance of another vehicle in relation to the vehicle, among other examples. The VLA system may store the infrastructure data in a world model. The VLA system may generate, using the world model, a data structure representing predicted future velocities on the roadway portion by position and time by applying a traffic flow model to the world model. The traffic flow model may be, for example, an artificial intelligence model trained using at least one of supervised learning, unsupervised learning, reinforcement learning, online learning, or the like.

The VLA system may transmit a control signal to the removable ICU provided in a vehicle for controlling operation of the vehicle based on the generated data structure. In some implementations, the ICU may be connected to a controller of the vehicle. The controller may include a computing device on board the vehicle. In an example, the control signal can be a specific control parameter (e.g., specific control parameter values) that may be used to control a component of the powertrain of the vehicle. In another example, the control signal can be or include data that the ICU can use to obtain the control parameter. For example, the ICU may be or include a machine leaning model that uses at least portions of the control signal to obtain (e.g., infer, output) the control parameter that can be used to control the component of the powertrain of the vehicle. The control parameter can depend on the capabilities of the ICU and/or of the vehicle.

As used herein, the term “model” may include, among other things, at least one of a classic planning model, an artificial intelligence (AI) model, or a machine-learning (ML) model that uses supervised learning, unsupervised learning, reinforcement learning, or the like. A model may be based on data that was generated in the past and may be used to predict future data. For example, a long-term shared world model of a roadway portion may store data about average velocities and congestion (e.g., number of vehicles per unit distance) of the roadway portion in the past (e.g., at multiple times in the past three years) and be used to predict the average velocities and the congestion of the roadway portion in the future (e.g., next Monday morning at 9 am). The prediction may be made, for example, using AI or ML techniques or other mathematical modeling techniques.

For the sake of clarity of description, examples described herein are described in the context of (but not limited in scope to) a controlled roadway region in which finished vehicles are managed and transported. As used herein, the term “finished vehicle” may refer to an at least partially assembled vehicle that has completed a manufacturing process and is ready for distribution, sale, or transportation to another location (e.g., for testing, validation, further manufacturing, troubleshooting, etc.). It should be recognized that the apparatuses, systems, processes, and/or techniques applicable to the finished vehicle scenarios described herein are equally applicable to any controlled roadway region, whether or not related to finished vehicles. In the context of finished vehicles, implementations may be described with reference to a finished vehicle logistics autonomy (FVLA) system, which is a VLA system located outside of a finished vehicle and configured to determine driving operations for controlling the finished vehicle. However, the nature of the systems, devices, apparatuses, techniques and processes associated with a finished vehicle environment are equally applicable to any other controlled roadway environment, as it is the characteristics of the controlled roadway that enable the functionality and advantages thereof, and not the fact that the controlled roadway may be specifically a controlled roadway associated with finished vehicle logistics. As such, references herein to an FVLA system may be references to a VLA system that is not limited to a finished vehicle environment.

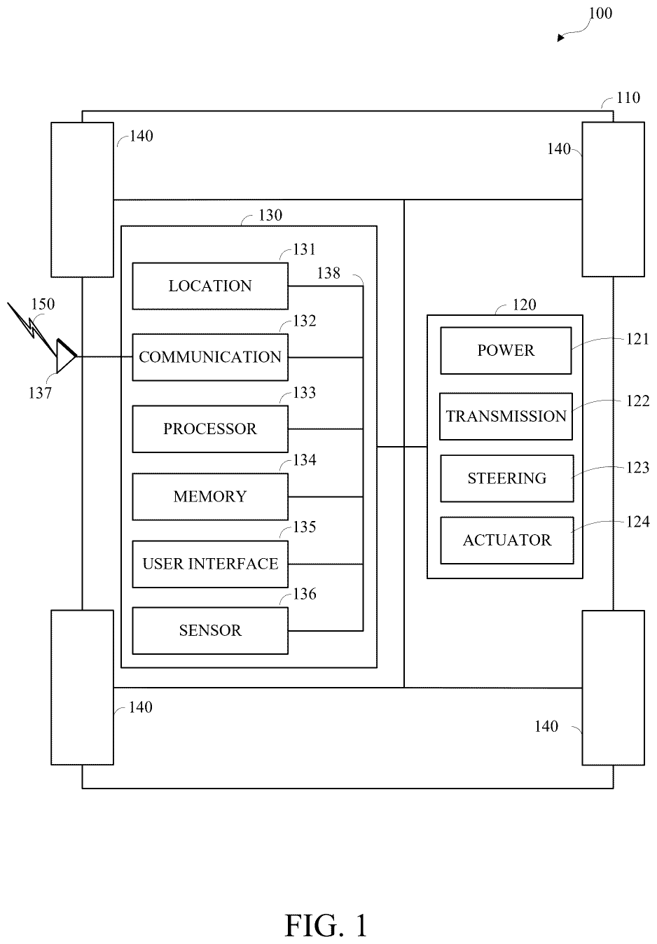

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or velocity, of the vehicle 100. For example, the location unit may include or be in communication with, a global positioning system (GPS) unit, a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, lidar, GPS, GNSS, internal measurement unit (IMU), cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory follower. For example, the controller 130 may include the trajectory follower. The trajectory controller may be operable to obtain information describing a current state of the vehicle 100 and a route planned for the vehicle 100, and, based on this information, to determine and optimize a trajectory for the vehicle 100. In some embodiments, the trajectory follower may output signals operable to control the vehicle 100 such that the vehicle 100 follows the trajectory that is determined by the trajectory follower. In some embodiments, the trajectory follower may follow a trajectory that is determined by an external system (e.g., an FVLA system). A trajectory may include an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

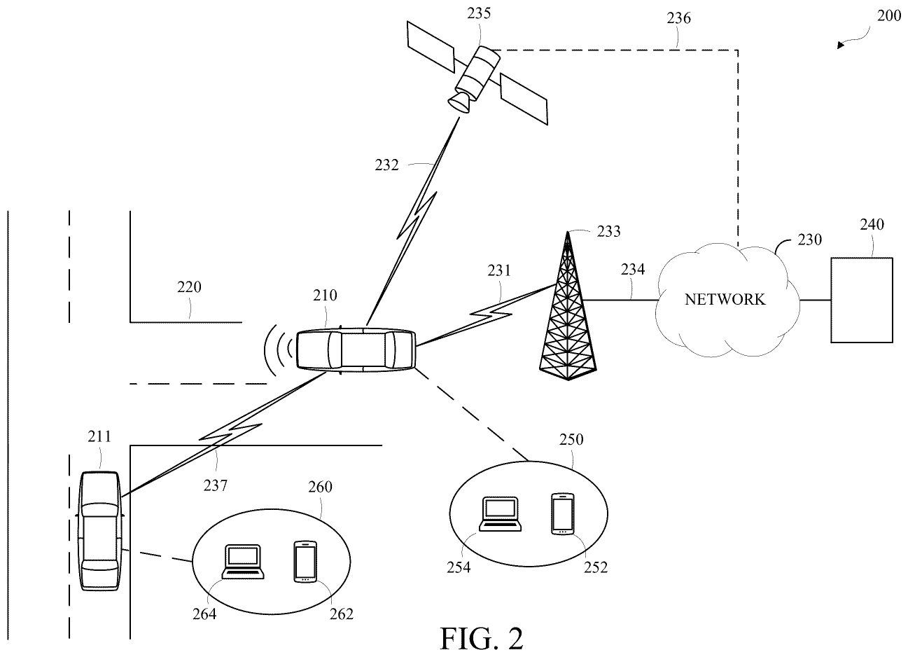

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the network 230.

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, velocity information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, an Internet of Things (IoT) network, or any other electronic communication system. The electronic communication network 230 may use a communication protocol, such as transmission control protocol (TCP), user datagram protocol (UDP), internet protocol (IP), real-time transport protocol (RTP), HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a velocity sensor, a wheel velocity sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, and one communication device 240, any number of vehicles, networks, and/or computing devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

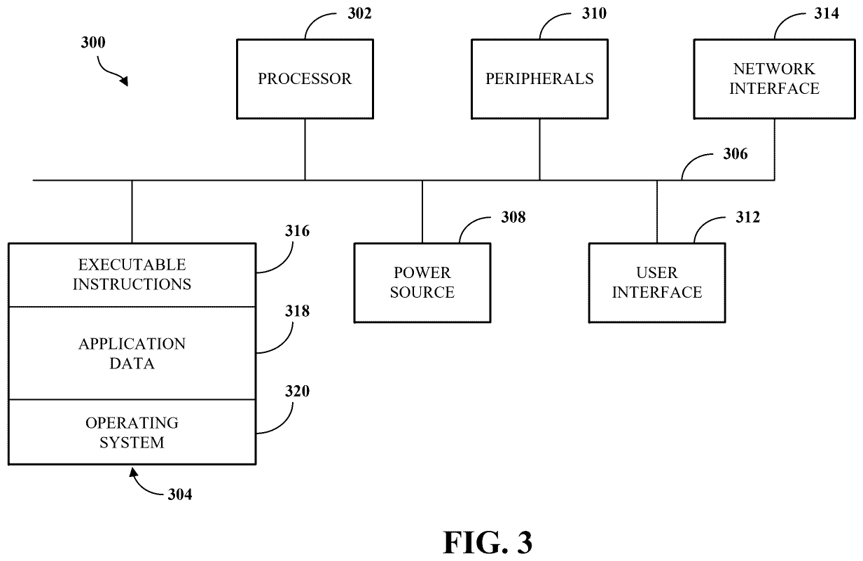

FIG. 3 shows a block diagram of an example of a computing device 300 capable of performing functions described herein. The computing device 300 may be, be similar to, include, or be included in, an apparatus for performing one or more methods, processes, algorithms, operations, tasks, and/or techniques, as described herein. The computing device 300 may be, be similar to, include, or be included in, an ICU, an FVLA system, a fleet management device, a tele-operation device, a sensor, a communication device, a vehicle controller (e.g., the controller 130 shown in FIG. 1) and/or a vehicle computer, among other examples. The computing device 300 includes components or units, such as a processor 302, a memory 304, a bus 306, a power source 308, peripherals 310, a user interface 312, a network interface 314, other suitable components, or a combination thereof. One or more of the memory 304, the power source 308, the peripherals 310, the user interface 312, or the network interface 314 can communicate with the processor 302 via the bus 306.

The processor 302 may be a central processing unit, such as a microprocessor, and may include single or multiple processors having single or multiple processing cores. The processor 302 can include another type of device, or multiple devices, configured for manipulating or processing information. For example, the processor 302 can include multiple processors interconnected in one or more manners, including hardwired or networked. The operations of the processor 302 can be distributed across multiple devices or units that can be coupled directly or across a local area or other suitable type of network. The processor 302 can include a cache, or cache memory, for local storage of operating data or instructions.

The memory 304 includes one or more memory components, which may each be volatile memory or non-volatile memory. For example, the volatile memory can be random access memory (RAM) (e.g., a DRAM module, such as DDR SDRAM). In another example, the non-volatile memory of the memory 304 can be a disk drive, a solid state drive, flash memory, or phase-change memory. In some implementations, the memory 304 can be distributed across multiple devices. For example, the memory 304 can include network-based memory or memory in multiple clients or servers performing the operations of those multiple devices.

The memory 304 can include data for immediate access by the processor 302. For example, the memory 304 can include executable instructions 316, application data 318, and an operating system 320. The executable instructions 316 can include one or more application programs, which can be loaded or copied, in whole or in part, from non-volatile memory to volatile memory to be executed by the processor 302. For example, the executable instructions 316 can include instructions for performing techniques of this disclosure. In some implementations, the application data 318 can include functional programs, such as a computational programs, analytical programs, database programs, and so on. The operating system 320 can be, for example, Microsoft Windows®, Mac OS X®, or Linux®; an operating system for a mobile device, such as a smartphone or tablet device; or an operating system for a non-mobile device, such as a mainframe computer.

The power source 308 provides power to the computing device 300. For example, the power source 308 can be an interface to an external power distribution system. In another example, the power source 308 can be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery.

The peripherals 310 may include one or more sensors, detectors, or other devices configured for monitoring the computing device 300 or the environment around the computing device 300. For example, the peripherals 310 can include a geolocation component, such as a GPS location unit. In another example, the peripherals can include a temperature sensor for measuring temperatures of components of the computing device 300, such as the processor 302. In some implementations, the computing device 300 can omit the peripherals 310.

The user interface 312 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 314 provides a connection or link to a network (e.g., the electronic communication network 230 shown in FIG. 2). The network interface 314 can be a wired network interface or a wireless network interface. The computing device 300 can communicate with other devices via the network interface 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 300 can communicate with a database server.

The network interface 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a vehicle, a system, or a device as taking an action (such as performing, determining, initiating, receiving, calculating, deciding, etc.) are to be understood that some appropriate component of the vehicle, system, or device as taking the action. Such components may refer to hardware and/or software configured to take the action.

An apparatus, computing device (e.g., the computing device 300), system, and/or vehicle, described herein may include one or more chips, system-on-chips (SoCs), chipsets, packages, and/or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include a memory system in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 3, such as a single processor or a combination of multiple different processors. Reference to “one or more processors” should be understood to refer to any one or more of the processors described in connection with FIG. 3.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 3. For example, operation described as being performed by one or more memories can be performed by the same subset of the one or more memories or different subsets of the one or more memories.

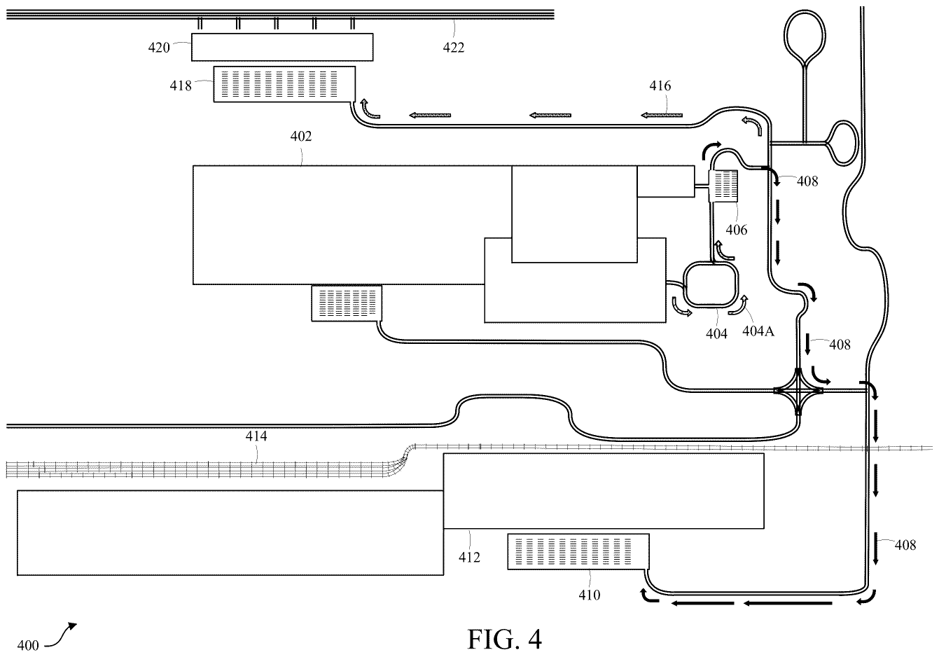

FIG. 4 illustrates an example of a controlled roadway region 400, in accordance with the present disclosure. The controlled roadway region 400 may be, be similar to, include, or be included in, an automotive manufacturing and distribution facility. The controlled roadway region 400 encompasses various interconnected areas and facilities designed to manage the flow of finished vehicles from production to distribution.

As shown, the controlled roadway region 400 may include a factory 402 at which vehicles (or one or more aspects thereof) are assembled and emerge as finished vehicles. The journey of a finished vehicle from the assembly line to its final destination involves numerous steps and potential bottlenecks. Adjacent to the factory 402 is a test course 404, where newly manufactured vehicles may undergo initial performance and quality checks. This proximity allows for quick identification and resolution of any issues that may arise immediately after production.

A handover lot 406, situated near the factory 402, serves as a transition point in the logistics chain. It may function as a staging area where vehicles are prepared for the next phase of their journey, whether that involves further testing, temporary storage, or immediate distribution. The presence of this handover lot 406 underscores the benefits of efficient space utilization and seamless transitions between different stages of the post-production process. In some implementations, a finished vehicle that emerges from the factory 402 may follow a first route (indicated by the arrows labeled 404A) as it traverses the test course 404 and then into the handover lot 406. The finished vehicle may be driven by a human driver (e.g., a manufacturing engineer) off of the assembly line, out of the factory 402, through the test course 404, and into the handover lot 406 at which time the finished vehicle is handed over to another human driver to be driven to a next location.

As shown, for example, the finished vehicle may exit the handover lot 406 and be driven along a second route (indicated by the arrows labeled 408) to a parking lot 410 associated with a railway distribution hub 412. The railway distribution hub 412, which includes a railyard 414, offers a high-volume transportation option for long-distance vehicle delivery. Some finished vehicles may instead take a third route (indicated by the arrows labeled 416) to a parking lot 418 associated with a trucking distribution hub 420, which may facilitate loading finished vehicles onto trucks for transportation via a highway 422. The trucking distribution hub 420 provides flexibility for shorter-distance transportation or for reaching areas not serviced by rail.

The traffic patterns within the controlled roadway region 400 may be characterized by a unique blend of predictable and variable elements. In some aspects, the majority of vehicles traversing this area may follow predetermined routes, creating a structured flow of traffic. These routes may typically be short, designed to efficiently move finished vehicles from the factory 402 through various stages such as the test course 404, handover lot 406, and ultimately to distribution points like the railway distribution hub 412 or trucking distribution hub 420. However, the controlled roadway region 400 may not be exclusively populated by finished vehicles on predetermined paths.

In some implementations, the roadways within the controlled region 400 may also accommodate other types of vehicles. For instance, employees' personal vehicles may be present, traversing routes to parking areas or between different facilities within the complex. Additionally, service vehicles, such as maintenance trucks or forklifts, may operate within the area, following less predictable patterns as they respond to various needs across the facility. Furthermore, the controlled roadway region 400 may not be limited to vehicular traffic. Pedestrians, including employees, visitors, or maintenance personnel, may be present in certain areas, necessitating additional considerations for safety and traffic management.

Despite the relatively short distances of the predetermined routes within the controlled roadway region 400, the cumulative impact of using human drivers for these journeys may be substantial. In some cases, the high volume of finished vehicle production (which may exceed, for example, 100,000 vehicles per year) may result in an extremely high total of driven miles and drive time when human drivers are employed to move vehicles along these routes. This accumulation of short trips may translate into significant labor costs, as well as increased potential for human error or inconsistency in vehicle handling. Moreover, the repetitive nature of these short drives may lead to driver fatigue or reduced attention, potentially compromising safety and efficiency.

In light of these challenges, a temporary automated solution, such as the one provided by the present disclosure, may offer important benefits in this scenario. By implementing a system for autonomous control of finished vehicles within the controlled roadway region 400, manufacturers may potentially reduce labor costs associated with short-distance vehicle movements. In some implementations, this approach may also enhance consistency in vehicle handling and routing, potentially improving overall efficiency and reducing the likelihood of minor damages or delays that can occur with frequent human interventions. Furthermore, an automated system may be capable of operating continuously, potentially allowing for more flexible and extended operational hours without the limitations imposed by human driver shifts or fatigue considerations.

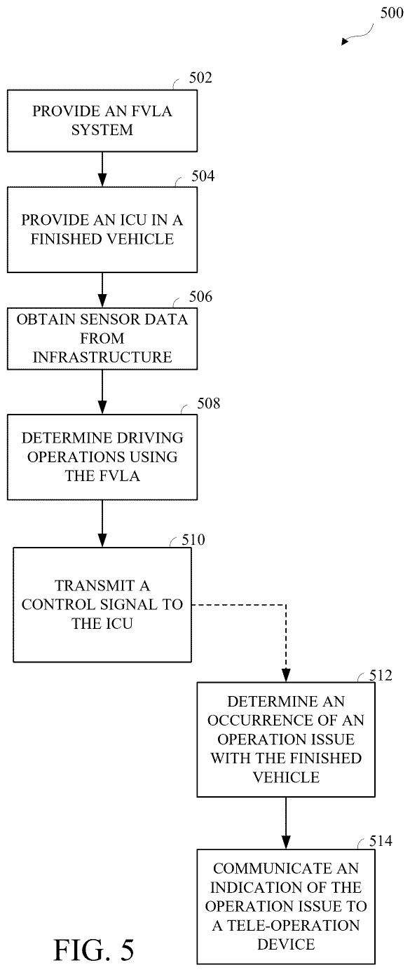

FIG. 5 is a flow diagram illustrating an example of a process 500 for controlling a finished vehicle in a controlled roadway region, in accordance with the present disclosure. Some implementations of controlling a finished vehicle in a controlled roadway region may include moving the finished vehicle from an assembly line to a distribution hub, moving the finished vehicle from the assembly line to a test course, traversing the test course, and/or moving the finished vehicle from the assembly line to an examination area, among other examples. The controlled roadway region may include any type of controlled roadway region such as, for example, the controlled roadway region 400 shown in FIG. 4.

At 502, an FVLA system located outside of a finished vehicle is provided. This FVLA system may be configured to determine driving operations for controlling the finished vehicle. In some aspects, the FVLA system may be implemented as a cloud-based system, utilizing advanced computing resources to process data and generate control instructions. The FVLA system may be designed to interface with various components of the controlled roadway region 400, such as the infrastructure components along the roadway, the railway distribution hub 412, and the trucking distribution hub 420.

At 504, a removable ICU for temporary installation in the finished vehicle is provided. The ICU may include at least one sensor, which may be used to gather data about the vehicle's environment and operational status. In some implementations, the ICU may be designed to be easily installed and removed from various vehicle models, allowing for flexibility in the types of vehicles that can be controlled within the system. The ICU may be temporarily installed in vehicles as they exit the factory 402 and/or after they reach the handover lot 406, among other examples. The FVLA system and ICU may enable autonomous control throughout the controlled roadway region 400.

At 506, the FVLA system obtains sensor data from an infrastructure. The infrastructure may include any number of different hardware and/or software components configured to gather data for use by the FVLA system. For example, the infrastructure may include sensors such as, for example, radar, LIDAR, cameras, and/or any number of other types of sensors. In some implementations, the infrastructure may include one or more of the sensors that are typically installed in autonomous vehicles such as, for example, autonomous vehicles built for Level 4 (L4) (also referred to as “high driving automation” (HAD)) autonomous driving (AD) operations.

At 508, the FVLA system generates driving instructions based on the sensor data. The driving instructions are intended for controlling the finished vehicle to traverse a transportation network of the controlled roadway region. The transportation network may include various elements depicted in FIG. 4, such as the roadway, the test course 404, and the paths leading to the distribution hubs 412 and 420. In generating these instructions, the FVLA system may take into account factors such as the current location of the vehicle, its destination, traffic conditions within the controlled roadway region, and any scheduled testing or quality control procedures.

At 510, the FVLA system transmits a control signal to the ICU, where the control signal is indicative of the driving instructions generated in step 508. This transmission may occur wirelessly, utilizing communication infrastructure within the controlled roadway region 400. The communication infrastructure may include any number of different types of wireless communication networks such as, for example, a private cellular network (e.g., using an unlicensed 5G band), an IoT network, and/or a public cellular network, among other examples. The control signal may contain detailed instructions for the vehicle's movement, including speed, direction, and specific actions to be taken at various points along its route.

In some implementations, the driving instructions, when executed by a processor of the ICU, may be configured to cause the ICU to control the finished vehicle to drive from an assembly line to at least one of a test course or a distribution hub. For example, the instructions may direct the vehicle to exit the factory 402 and proceed to the test course 404 for initial quality checks. Alternatively, the instructions may guide the vehicle directly to the railway distribution hub 412 or the trucking distribution hub 420, depending on its final destination and the chosen mode of transportation.

The FVLA system used in this method may include cloud-based L4 AD software. This advanced software may enable the system to handle complex driving scenarios within the controlled roadway region 400 without human intervention under normal circumstances. The L4 autonomy may allow the vehicles to navigate intersections and make decisions about routing and movement without constant human oversight.

To facilitate communication between the FVLA system and the finished vehicle, the ICU may include a communication component configured to communicate with the FVLA system. This communication component may utilize various wireless technologies to maintain a constant connection with the FVLA system, ensuring that the vehicle can receive updated instructions and report its status in real-time as it moves through the controlled roadway region 400.

For integration with the vehicle's systems, the ICU may comprise a connection component configured to connect with a control area network (CAN) bus of the finished vehicle. This connection allows the ICU to interface directly with the vehicle's internal systems, enabling precise control over the vehicle's movements and functions. Through the CAN bus connection, the ICU may be able to control the vehicle's steering, acceleration, braking, and other critical functions necessary for autonomous operation within the controlled roadway region 400.

In some aspects of the process 500, additional steps may be implemented to enhance the system's flexibility and safety. For instance, at 512, the FVLA system may determine an occurrence of an operation issue with a finished vehicle and, at 514, the FVLA system may communicate an indication of the operation issue to a tele-operation device associated with a remote operator. In some examples, the process 500 may include receiving additional instructions from the tele-operation device to control the finished vehicle, and controlling the finished vehicle based on these additional instructions. In other examples, the additional instructions may be provided directly from the tele-operation device to the ICU. In this way, some implementations may allow for human intervention when necessary, such as in unusual situations or when the autonomous system encounters a scenario it cannot handle independently.

To enhance the system's ability to monitor the vehicle's surroundings, the ICU may comprise a camera that is configured to be attached to a rear-view mirror or mounted to a dashboard of the finished vehicle. This camera may provide visual data to the FVLA system, allowing for more informed decision-making and potentially enabling features such as obstacle detection and avoidance as the vehicle navigates through the controlled roadway region 400.

By leveraging advanced autonomous driving technologies, removable ICUs, and a centralized logistics autonomy system, various implementations may enhance the efficiency and flexibility of post-production vehicle logistics.

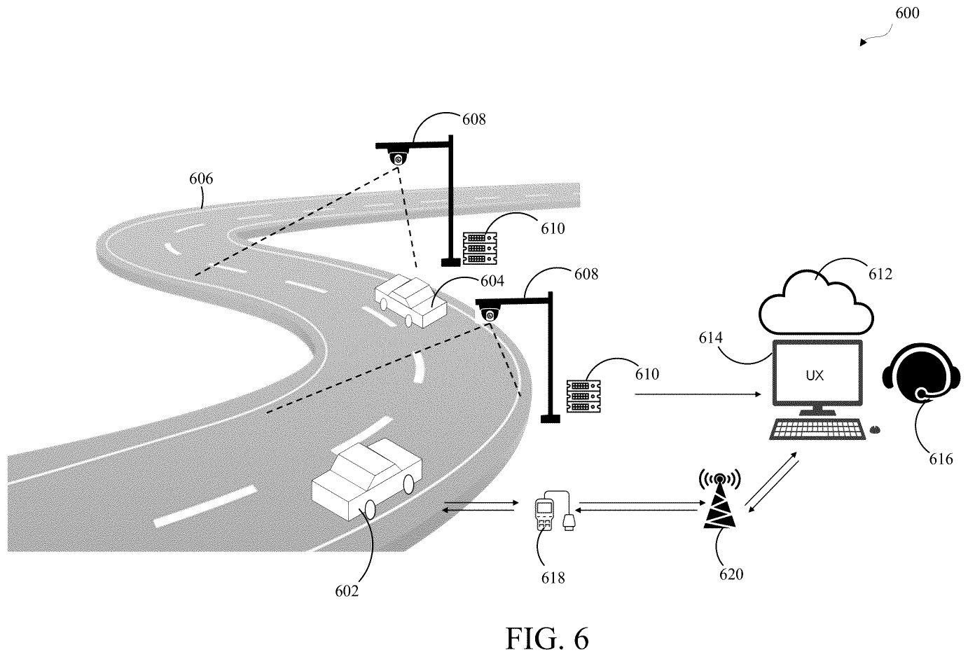

FIG. 6 is a schematic diagram showing an operating environment 600 within which aspects of the system and apparatuses described herein may be implemented. The operating environment 600 may be, be similar to, include, or be included in, a controlled roadway region where finished vehicles 602 and 604 are managed and transported autonomously such as, for example, the controlled roadway region 400 shown in FIG. 4. The operating environment 600 may be, be similar to, include, or be included in, the vehicle transportation and communication system 200 shown in FIG. 2.

The operating environment 600 includes a roadway 606. Along the roadway 606, multiple infrastructure components 608 are positioned. The infrastructure components 608 may include various sensors, cameras, and communication devices that continually monitor the environment and the vehicles 602 and 604. For example, the infrastructure components 608 may incorporate LiDAR sensors or radar systems to provide detailed environmental data.

The infrastructure components 608 may be implemented in various ways. In some implementations, the infrastructure components 608 may be affixed to and/or integrated into existing roadside equipment, such as street lights, traffic signals, or road signs. This approach may leverage pre-existing infrastructure, potentially reducing installation costs and minimizing additional visual clutter in the environment. For example, cameras or sensors may be fitted to street light poles, providing elevated vantage points for monitoring traffic flow and vehicle movements. In some implementations, the infrastructure components 608 may be standalone devices specifically designed for use with the FVLA system. These purpose-built units may be optimized for the particular requirements of the controlled roadway region, potentially offering enhanced performance or specialized capabilities. In some implementations, a combination of retrofitted existing equipment and new standalone devices may be used to create a comprehensive sensor network that covers the controlled roadway region.

The data collected by the infrastructure components 608 is fed into a perception system 610. The perception system 610 may include hardware, software, or a combination of hardware and software configured to obtain raw data from the infrastructure components 608 and process the raw data to provide sensor data, sometimes referred to as “perception data.” The perception system 610 may use advanced algorithms to detect and track vehicles, identify potential obstacles, and monitor traffic flow within the controlled roadway region.

The operating environment 600 includes an FVLA system 612. The FVLA system 612, which may be implemented as described in step 502 of FIG. 5, may be responsible for determining driving operations for controlling the finished vehicles. The FVLA system 612 receives processed data from the perception system 610 and uses this information to generate driving instructions for each vehicle in the controlled roadway region.

The operating environment 600 may include a user interface 614 communicatively coupled to the FVLA system 612. The user interface 614 may allow an operator 616 (e.g., a fleet operator) to monitor the entire system, view the status of individual vehicles, and intervene if necessary. In some implementations, the user interface 614 may serve as a tele-operation device, as described in the context of FIG. 5, enabling the operator 616 to provide additional instructions or take control of a vehicle in case of an operational issue.

Each finished vehicle 602 and 604 is equipped with an ICU 618. The ICU may be, be similar to, include, or be included in, the removable ICU described in step 504 of FIG. 5. The ICUs 618 receive control signals from the FVLA system 612 and execute the driving instructions, controlling the vehicles' movements within the operating environment 600.

Communication between the FVLA system 612 and the ICUs 618 in the vehicles is facilitated by an access point 620. This access point 620 may use wireless technology to transmit control signals and receive status updates from the vehicles, ensuring constant connectivity throughout the controlled roadway region. The wireless technology may include, for example, cellular technology.

In some implementations, the operating environment 600 could be adapted to handle various scenarios within the controlled roadway region. For instance, the FVLA system 612 may manage the movement of finished vehicles from the factory 402 to the test course 404, as described in FIG. 4. The FVLA system 612 could generate specific driving instructions for navigating the test course, while the infrastructure components 608 monitor the vehicle's performance during testing. In some implementations, the operating environment 600 may facilitate the efficient transfer of vehicles to the distribution hubs. The FVLA system 612 could coordinate the movement of multiple vehicles simultaneously, optimizing routes to the railway distribution hub 412 or the trucking distribution hub 420 based on real-time conditions and scheduling requirements.

Any one or more of the infrastructure components 608, the perception system 610, the FVLA system 612, the user interface 614, the access point 620, and/or the ICU 618, may be, be similar to, include, or be included in, the computing device 300 shown in FIG. 3. Similarly, the vehicle 602 and/or the vehicle 604 may be, be similar to, include, or be included in, the vehicle 100 shown in FIG. 1.

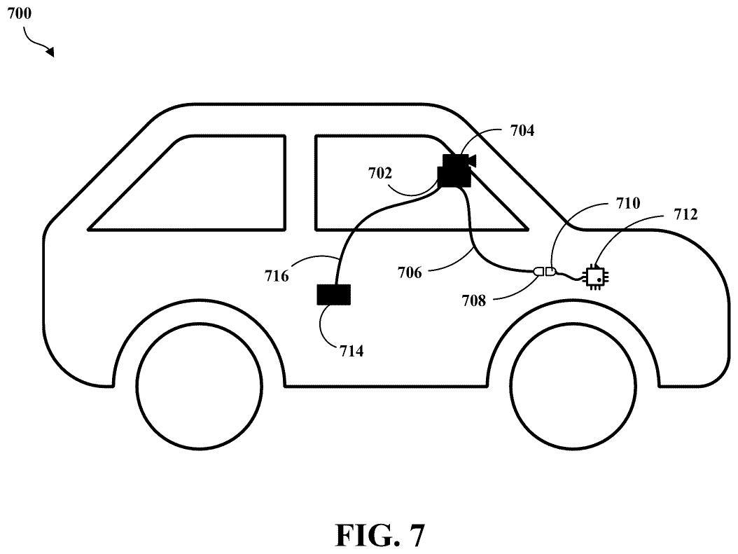

FIG. 7 is a diagram of an example of a vehicle 700 having an ICU 702 temporarily installed therein, in accordance with the present disclosure. The vehicle 700 represents a finished product that has at least partially completed the manufacturing process and is ready for autonomous navigation within a controlled roadway region. It may be any type of vehicle produced in the factory 402, as shown in FIG. 4, and is now prepared for movement to various locations such as the test course 404 or distribution hubs 412 and 420. The vehicle 700 may be, be similar to, include, or be included in, the finished vehicle 602 and/or the finished vehicle 604 shown in FIG. 6. The ICU 702 may be, be similar to, include, or be included in, the ICU 618 shown in FIG. 6.

The ICU 702 may be designed to be easily installed and removed, allowing for flexibility in equipping different vehicles with autonomous capabilities as they move through the controlled roadway region. The ICU 702 is shown mounted in a position that provides optimal access to the vehicle's systems and clear line of sight for any integrated sensors. This placement may be on the dashboard or windshield area, ensuring that the unit does not interfere with the vehicle's standard operations or safety features.

A camera 704 is connected to the ICU 702, serving as a sensor for the autonomous system and/or for tele-operations. The camera 704 is positioned to capture the view in front of the vehicle 700, providing visual data that the FVLA system 612 can use for navigation, obstacle detection, and environmental awareness. The ICU 702 is connected to the vehicle's systems (e.g., the CAN) via a connection cable 706 which serves as the primary interface between the ICU 702 and the vehicle's internal network, allowing for the exchange of data and control signals. The connection cable 706 may be designed to be robust and secure, ensuring reliable communication between the ICU 702 and the vehicle 700 even in challenging environmental conditions or during complex maneuvers.

At one end of the connection cable 706 is an ICU connector 708. This connector is specifically designed to interface with the ICU 702, providing a secure and efficient connection point. The ICU connector 708 may include multiple pins or interfaces to accommodate various types of data transmission and power supply to the ICU 702 via a CAN connector 710 coupled to the CAN of the vehicle 700. The CAN 712 includes a standard protocol used in most modern vehicles for internal communications between different electronic control units. By connecting to the CAN 712, the ICU 702 gains access to a wide range of vehicle data and control systems, allowing it to monitor the vehicle's status and issue commands for steering, acceleration, braking, and other functions necessary for autonomous operation. The ICU 702 acts as the on-board agent of the FVLA system, executing the driving instructions received from the FVLA system and providing real-time feedback about the vehicle's status and surroundings. This temporary installation of autonomous capabilities allows for efficient and flexible management of finished vehicles within the controlled roadway region, supporting the complex logistics operations described in the context of FIG. 4 and FIG. 5.

The electronics component 714 may serve as an additional processing unit or interface module for the ICU system. In some implementations, the electronics component 714 may include a microprocessor, memory, and various input/output interfaces to enhance the capabilities of the ICU 702. The electronics component 714 may be connected to the ICU 702 via a connection cable 716, which may allow for high-speed data transfer between the two components. This arrangement may provide additional computational power for complex autonomous driving algorithms or serve as a backup system for critical functions. In some cases, the electronics component 714 may also include specialized hardware for specific tasks such as image processing, sensor fusion, or real-time decision making. The modular nature of this setup may allow for easy upgrades or replacements of the electronics component 714 without affecting the core functionality of the ICU 702.

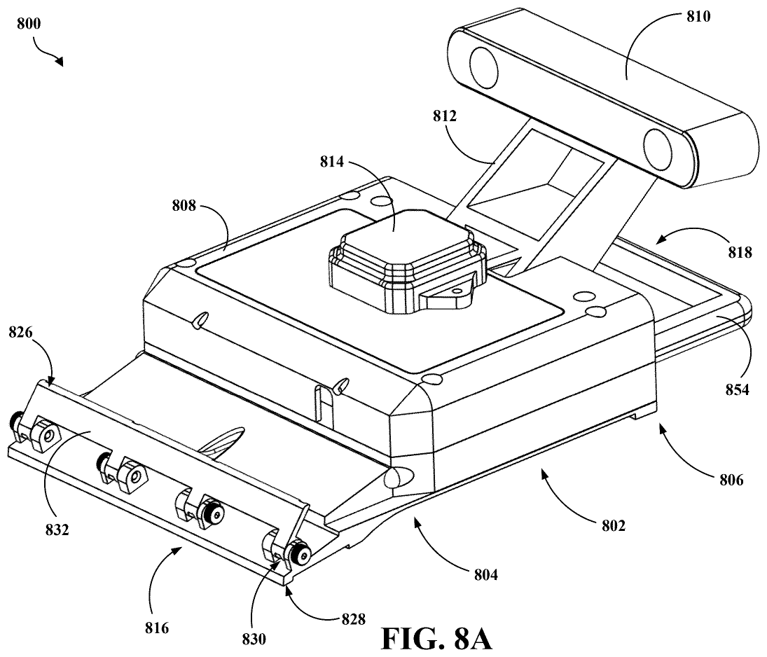

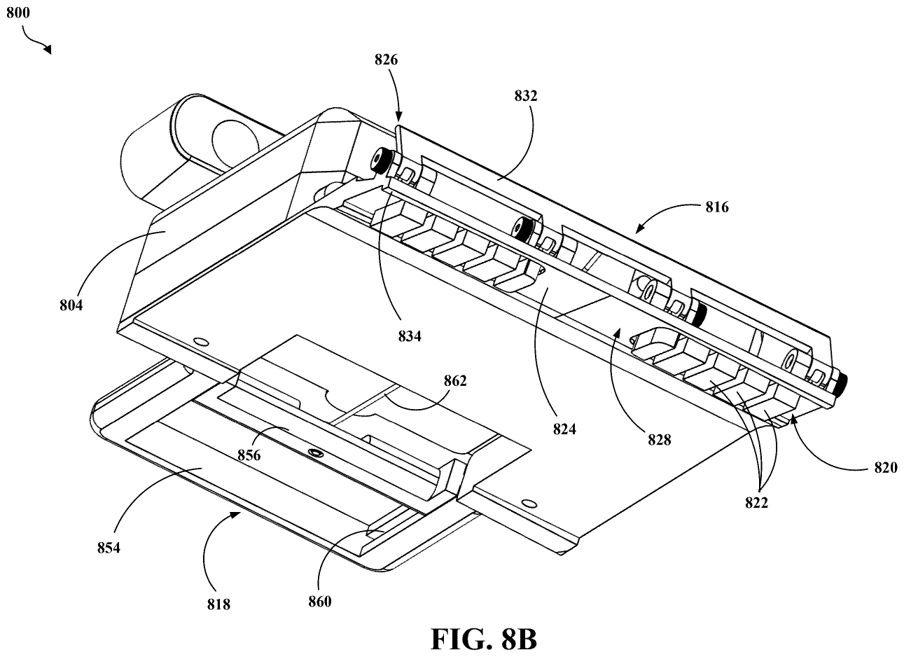

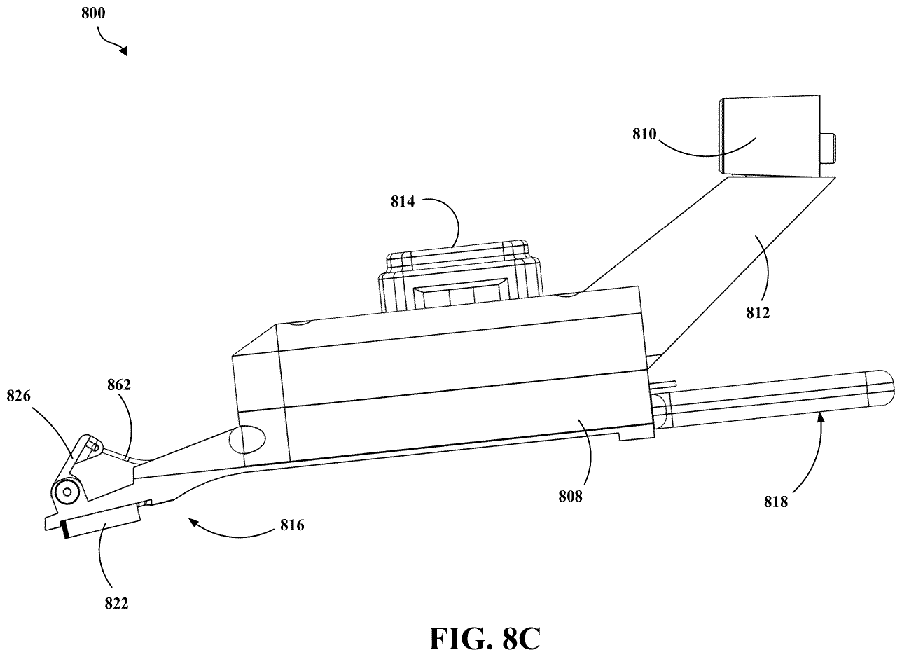

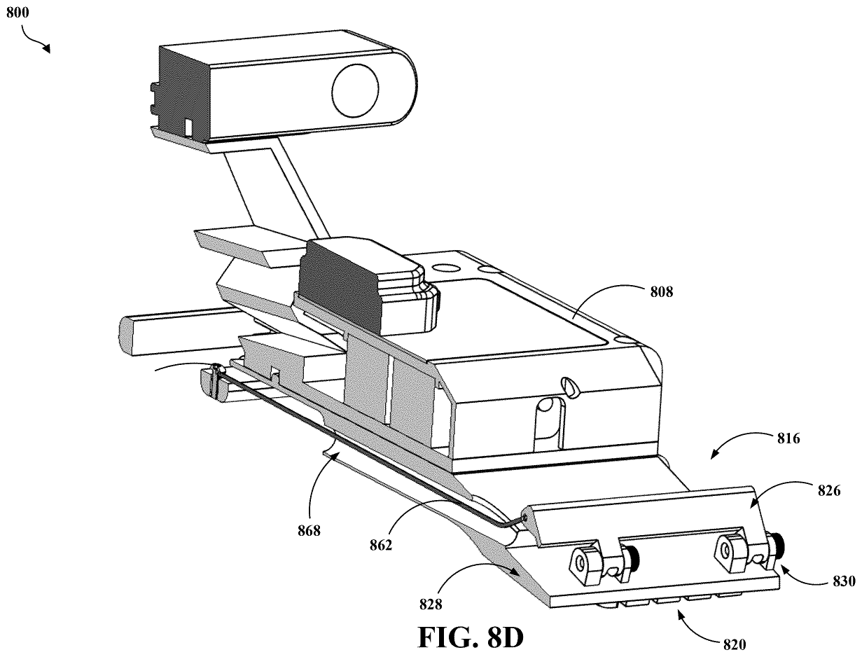

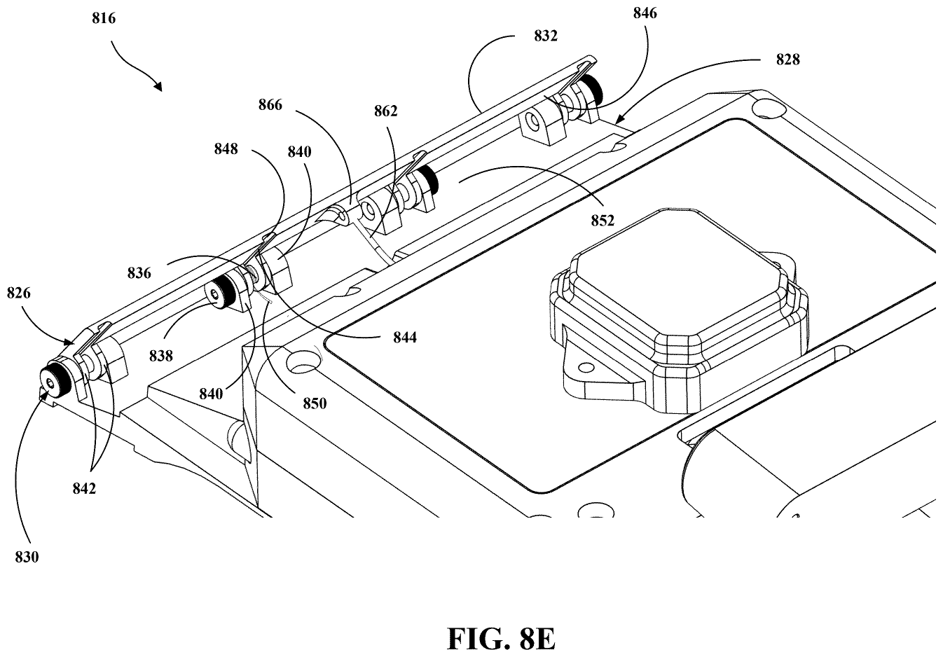

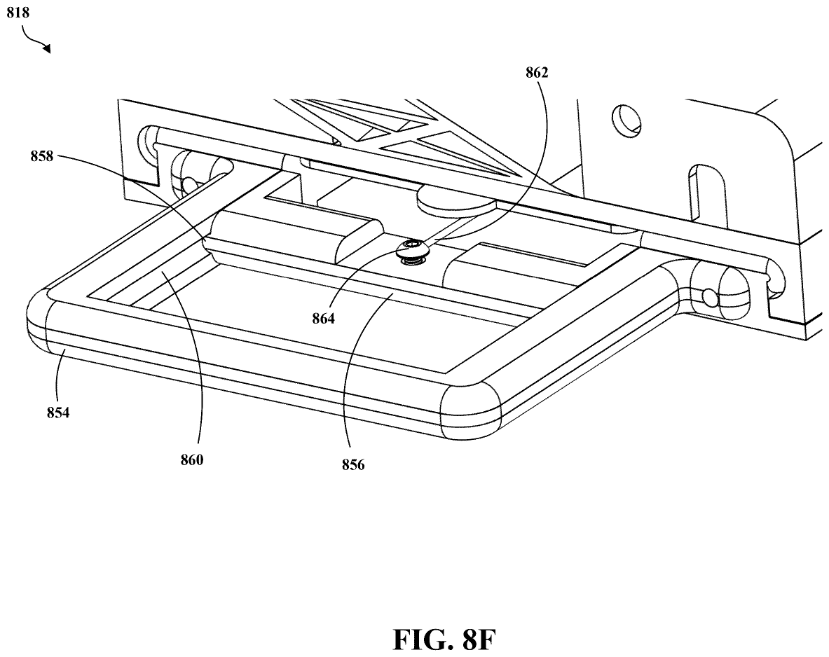

FIGS. 8A-8F are diagrams illustrating an example of a sensor component 800 of an ICU, in accordance with the present disclosure, in accordance with the present disclosure. The sensor component 800 may be, be similar to, include, or be included in the ICU 702 shown in FIG. 7.

As shown in FIG. 8A, the sensor component 800 comprises a body 802 with a front end 804 and a rear end 806. The body 802 is enclosed by a housing 808, which provides structural support and protection for the internal components. The housing 808 may be constructed from durable materials such as high-impact plastic, aluminum, or composite materials to withstand the rigors of repeated installations and removals. In some implementations, the housing 808 may incorporate weatherproofing features to protect the internal components from environmental factors such as dust, moisture, or temperature fluctuations.

Mounted atop the housing 808 is a camera 810, which is supported by a camera attachment pillar 812. The camera 810 serves as a primary sensor for the ICU, capturing visual data of the vehicle's surroundings. In some embodiments, the camera 810 may be a high-resolution digital camera with a wide-angle lens to provide a broad field of view. Alternative implementations may include multiple cameras to offer different perspectives or specialized cameras such as infrared or thermal imaging cameras for enhanced environmental perception under various conditions.

Adjacent to the camera 810, a motion detection device 814 is integrated into the housing 808. This device may comprise various sensors such as accelerometers, gyroscopes, or a combination thereof, forming an inertial measurement unit (IMU). The motion detection device 814 provides crucial data about the vehicle's movement, including acceleration, deceleration, and changes in orientation. In some implementations, the motion detection device 814 may also include a geographical positioning component, such as a GPS receiver, to provide accurate location data for the vehicle.

The sensor component 800 features an attachment mechanism 816 extending from the front end 804 of the body 802. This mechanism is designed to securely fasten the sensor component 800 to a vehicle's dashboard, ensuring stability during operation while allowing for easy removal when necessary. The attachment mechanism 816 comprises an upper engagement member 826 and a lower engagement member 828, connected by a spring-loaded tension mechanism 830. This design allows the sensor component 800 to be firmly held in place between the vehicle's dashboard and windshield, accommodating variations in dashboard designs across different vehicle models.

The upper engagement member 826 includes an engagement surface 832 designed to contact the inner surface of the vehicle's windshield. This surface may be covered with a soft, non-abrasive material to prevent any damage to the glass. The lower engagement member 828 is shaped to rest securely on the dashboard's upper surface. In some implementations, the lower engagement member 828 may include adjustable or interchangeable components to better fit various dashboard contours. An engagement surface 834 of the lower engagement member 828 may be textured or coated to provide additional grip on the dashboard surface.

As shown, the attachment mechanism 816 includes an alignment feature 820, visible in FIG. 8B. This alignment feature 820 is configured to correspond with specific dashboard features, such as vents, speaker covers, or particular contours. For example, the alignment feature 820 may include one or more protrusions 822 extending from a lower surface 824 of the attachment mechanism 816. These protrusions 822 are designed to fit into dashboard vents or other recesses, ensuring consistent and accurate positioning of the sensor component 800 across multiple installations. The lower surface 824 may be contoured to match common dashboard shapes, further enhancing the stability of the attachment.

The alignment feature 820 may also be subject to variations in design. In some implementations, it may include adjustable or interchangeable protrusions to accommodate a wider range of dashboard designs. The alignment feature may also incorporate sensors, such as proximity sensors or pressure sensors, to provide feedback on the correct positioning of the sensor component. This feedback may be used to guide the installation process or to verify secure attachment before operation. The rear surface 846 of the upper engagement member 826 may include additional mounting points or interfaces for supplementary sensors or accessories.

To facilitate removal of the sensor component 800, a release mechanism 818 is incorporated at the rear end 806 of the body 802. The release mechanism 818 actuates at least one spring-loaded tension mechanism 830, which, as shown in detail in FIG. 8E, is a component of the attachment mechanism 816. The at least one spring-loaded tension mechanism 830 includes a torsion spring 836 secured by a pin 838 that passes through knuckles 840 and 842 of the lower and upper engagement members respectively. The first leg 844 of the torsion spring 836 engages with the upper engagement member 826, while the second leg 850 interacts with the lower engagement member 828. This configuration provides tension to hold the sensor component 800 in place while allowing for installation and removal. The channel 848 in the rear surface 846 of the upper engagement member 826 may guide the movement of the torsion spring 836 during operation.

The cable 862 runs through the sensor component 800, as seen in various figures. This cable may serve to transmit force from the release mechanism 818 to the attachment mechanism 816. The cable 862 is anchored at a forward cable mount 866 and runs through a cable channel 868, which may help ensure neat and secure routing of the connection. As detailed in FIG. 8F, the release mechanism 818 includes a handle 854 connected to a carriage 856. The carriage 856 includes a protruding rail 858 configured to slide within a guide channel 860. When the handle 854 of the release mechanism 818 is pulled, it may cause the rail 858 of the carriage 856 to slide within the guide channel 860. This sliding motion may pull on the cable 862, which in turn may actuate the attachment mechanism 816 to disengage from the dashboard. The linear actuation provided by this cable system may allow for smooth and controlled release of the sensor component 800 from its mounted position in the vehicle. A fastener 864 may secure the cable 862 to the carriage 856, ensuring reliable force transmission.

In some implementations, the attachment mechanism 816 may include a single spring-loaded tension mechanism or multiple spring-loaded tension mechanisms. For example, two or more torsion springs may be used in parallel to distribute the tension more evenly across the upper and lower engagement members. This configuration may provide additional stability and accommodate a wider range of dashboard shapes and sizes. In some cases, the multiple spring-loaded tension mechanisms may be adjustable independently, allowing for fine-tuning of the attachment force based on the specific vehicle interior. The upper surface 852 of the lower engagement member 828 may include grooves or channels to guide the positioning of multiple tension mechanisms.

The release mechanism 818 may be adapted to include additional features for ease of use and safety. For example, it may incorporate a two-stage release process to prevent accidental detachment. In this configuration, the handle 854 may need to be rotated to a specific position before it can be pulled, adding an extra layer of security. Additionally, the release mechanism may include visual or tactile indicators to confirm when the sensor component is fully secured or ready for removal. The guide channel 860 may incorporate detents or locking positions to provide tactile feedback during the release process.

These variations and alternative designs may enhance the versatility, reliability, and user-friendliness of the sensor component, while maintaining its core functionality of providing temporary autonomous capabilities to finished vehicles in controlled roadway regions.

In some implementations, alternative mechanisms may be used as the release mechanism for the sensor component. These alternative mechanisms may provide different advantages in terms of ease of use, reliability, or compatibility with various vehicle interiors.

One alternative mechanism that may be employed is a pneumatic release system. This system may utilize compressed air to disengage the attachment mechanism from the dashboard. In some aspects, the pneumatic release system may include a small air compressor integrated into the body of the sensor component. The compressor may be connected to inflatable bladders positioned between the upper and lower engagement members. When activated, the compressor may inflate the bladders, creating pressure that separates the engagement members and releases the sensor component from the dashboard. This pneumatic system may provide a smooth and controlled release action, potentially reducing wear on the attachment mechanism components.

Another alternative mechanism that may be implemented is an electromagnetic release system. This system may utilize electromagnetic forces to disengage the attachment mechanism. In some cases, the electromagnetic release system may include electromagnets integrated into the upper and lower engagement members. When activated, these electromagnets may generate magnetic fields that counteract the force of the spring-loaded tension mechanism, allowing the sensor component to be easily removed from the dashboard. The electromagnetic system may offer precise control over the release action and may be particularly suitable for applications where a rapid or remote-controlled release is desired.

In some implementations, a shape memory alloy (SMA) actuator may be used as an alternative release mechanism. SMAs are materials that can change shape when heated and return to their original shape when cooled. An SMA actuator may be incorporated into the attachment mechanism, connecting the upper and lower engagement members. When an electrical current is applied to the SMA actuator, it may heat up and change shape, causing the engagement members to separate and release the sensor component from the dashboard. This SMA-based system may provide a compact and energy-efficient release mechanism, potentially reducing the overall size and power requirements of the sensor component.

These alternative release mechanisms may be selected based on factors such as the specific requirements of the vehicle environment, the desired speed and precision of the release action, and the overall design constraints of the sensor component. Each mechanism may offer unique advantages in terms of reliability, ease of use, or integration with other systems in the vehicle or the broader autonomous control infrastructure.

The sensor component 800 represents an advancement in the field of temporary vehicle automation, particularly in the context of vehicle logistics. By providing a removable, easy-to-install unit that can temporarily equip vehicles with autonomous capabilities, this disclosure addresses the challenge of efficiently moving vehicles through various processes without the need for permanent modifications. This solution may offer several advantages, including reduced labor costs, increased efficiency in vehicle handling, and the flexibility to quickly adapt to changing logistics requirements.

The ICU may be useful in various other situations beyond the controlled roadway region for finished vehicles. In some cases, the ICU may be employed in vehicle testing and development processes, allowing engineers to collect data and control prototype vehicles without permanent modifications. The ICU may also find applications in temporary autonomous vehicle fleets, such as those used for short-term events or exhibitions. In some implementations, the ICU may be utilized in vehicle rental services, enabling companies to offer autonomous features to customers without altering their entire fleet. Additionally, the ICU may prove valuable in emergency response scenarios, where rapid deployment of autonomous capabilities could assist in navigating hazardous environments or coordinating multiple vehicles during disaster relief efforts.

The modular nature of the sensor component 800 allows for easy upgrades or replacements of individual components, such as the camera 810 or motion detection device 814, without necessitating a complete redesign of the unit. This modularity also facilitates customization for different vehicle models or specific operational requirements within the controlled roadway region.

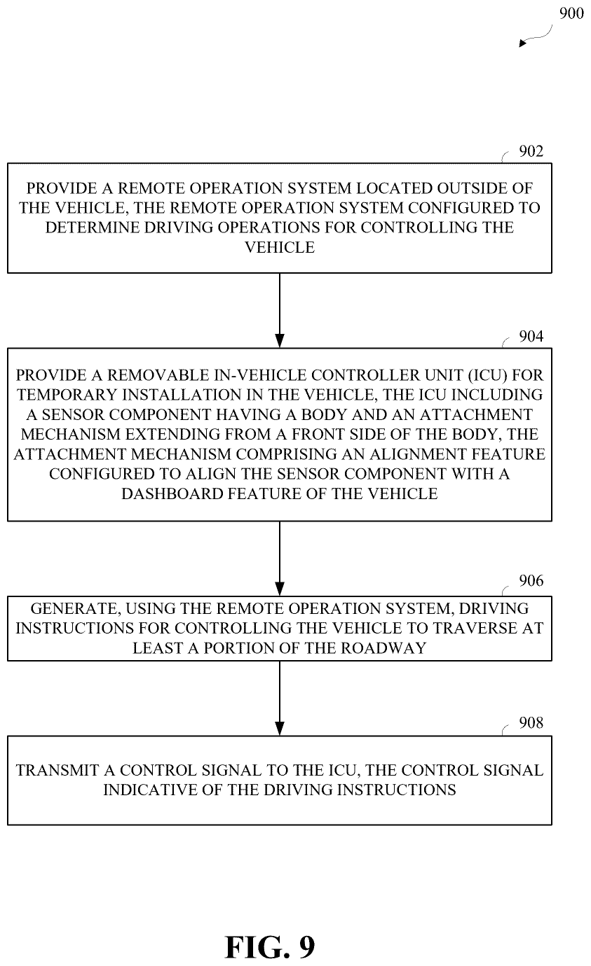

To further describe some implementations in greater detail, reference is next made to examples of techniques which may be performed by or using an ICU to control a vehicle. FIG. 9 is a flowchart of an example of a technique 900 associated with facilitating control of a vehicle. Some aspects of the technique 900 can be executed using computing devices, such as the systems, hardware, and software described with respect to FIGS. 1-8F. Some aspects of the technique 900 can be performed, for example, by executing a machine-readable program or other computer-executable instructions, such as routines, instructions, programs, or other code. Some of the steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, the technique 900 includes providing a remote operation system located outside of the vehicle, the remote operation system configured to determine driving operations for controlling the vehicle. At 904, the technique 900 includes providing a removable In-Vehicle Controller Unit (ICU) for temporary installation in the vehicle, the ICU including a sensor component having a body and an attachment mechanism extending from a front side of the body, the attachment mechanism comprising an alignment feature configured to align the sensor component with a dashboard feature of the vehicle. In some implementations, the ICU comprises a camera, the method further comprising receiving a video feed captured via the camera.

At 906, the technique 900 includes generating, using the remote operation system, driving instructions for controlling the vehicle to traverse at least a portion of the roadway. At 908, the technique 900 includes transmitting a control signal to the ICU, the control signal indicative of the driving instructions. In some implementations, transmitting the control signal includes transmitting a cellular communication over a private cellular network, the cellular communication including the control signal. In some implementations, the technique 900 includes providing a tele-operation component configured to facilitate tele-operation of the vehicle by a tele-operator, where the control signal is associated with the tele-operation component; and receiving, via the tele-operation component and from the ICU, one or more vehicle motion parameters.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology “or” is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. An apparatus for facilitating control of a vehicle, comprising:
a sensor component configured to be removably attached to a dashboard of the vehicle, the sensor component comprising:
a body having a front end and an opposite rear end;
an attachment mechanism extending from the front end, wherein the attachment mechanism is configured to temporarily attach the sensor component to the dashboard; and
a release mechanism extending from the rear end and operatively coupled to the attachment mechanism, wherein the release mechanism is configured to facilitate causing the attachment mechanism to detach from the dashboard.

2. The apparatus of claim 1, wherein the attachment mechanism comprises an alignment feature configured to align the sensor component with a dashboard feature of the vehicle.

3. The apparatus of claim 2, wherein the dashboard feature comprises at least one of a contour of the dashboard, a speaker cover coupled to the dashboard, or a vent defined in the dashboard.

4. The apparatus of claim 2, wherein the alignment feature comprises at least one protrusion extending away from a lower surface of the attachment mechanism, the at least one protrusion having a shape configured such that the at least one protrusion fits into at least one vent defined in the dashboard.

5. The apparatus of claim 1, wherein the attachment mechanism comprises:
an upper engagement member;
a lower engagement member; and
a spring-loaded tension mechanism configured to cause the upper engagement member to engage an inner surface of a windshield of the vehicle and the lower engagement member to engage an upper surface of the dashboard of the vehicle such that a tension applied between the upper engagement member and the lower engagement member causes the sensor component to be removably attached between the dashboard and the windshield.

6. The apparatus of claim 5, wherein the release mechanism comprises a carriage slidably engaged with a handle, wherein the carriage is configured to release the tension based on the carriage being pulled in a direction away from the rear end of the sensor component.

7. The apparatus of claim 1, the sensor component further comprising a digital camera and a motion detection device.

8. The apparatus of claim 7, wherein the motion detection device comprises at least one of a geographical positioning component or an inertial measurement unit.

9. The apparatus of claim 1, further comprising an electronics component communicatively coupled to the sensor component.

10. The apparatus of claim 9, wherein the electronics component comprises at least one of a computing device or a communication component.

11. An In-Vehicle Controller Unit (ICU) for controlling a vehicle, comprising:
a sensor component configured to be removably attached to a dashboard of the vehicle, the sensor component comprising at least one sensor;
a communication component comprising a transceiver configured to facilitate wireless communication with a wireless network node associated with a remote operation system; and
a connection assembly configured to communicably couple the ICU with a control area network (CAN) of the vehicle.

12. The ICU of claim 11, the sensor component comprising:
a body having a front end and an opposite rear end;
an attachment mechanism extending from the front end, wherein the attachment mechanism is configured to temporarily attach the sensor component to the dashboard; and
a release mechanism extending from the rear end and operatively coupled to the attachment mechanism, wherein the release mechanism is configured to facilitate causing the attachment mechanism to detach from the dashboard.

13. The ICU of claim 12, wherein the attachment mechanism comprises an alignment feature configured to align the sensor component with a dashboard feature of the vehicle, wherein the dashboard feature comprises at least one of a contour of the dashboard, a speaker cover coupled to the dashboard, or a vent defined in the dashboard.

14. The ICU of claim 12, wherein the attachment mechanism comprises:
an upper engagement member;
a lower engagement member; and
a spring-loaded tension mechanism configured to cause the upper engagement member to engage an inner surface of a windshield of the vehicle and the lower engagement member to engage an upper surface of the dashboard of the vehicle such that a tension applied between the upper engagement member and the lower engagement member causes the sensor component to be removably attached between the dashboard and the windshield.

15. The ICU of claim 11, wherein the at least one sensor comprises at least one of a digital camera, a geographical positioning component, or an inertial measurement unit.

16. The ICU of claim 11, further comprising an electronics component communicatively coupled to the sensor component, the electronics component comprising at least one of a computing device or the communication component.

17. A method of controlling a vehicle on a roadway, comprising:
providing a remote operation system located outside of the vehicle, the remote operation system configured to determine driving operations for controlling the vehicle;
providing a removable In-Vehicle Controller Unit (ICU) for temporary installation in the vehicle, the ICU including a sensor component having a body and an attachment mechanism extending from a front side of the body, the attachment mechanism comprising an alignment feature configured to align the sensor component with a dashboard feature of the vehicle;
generating, using the remote operation system, driving instructions for controlling the vehicle to traverse at least a portion of the roadway; and
transmitting a control signal to the ICU, the control signal indicative of the driving instructions.

18. The method of claim 17, wherein the ICU comprises a camera, the method further comprising receiving a video feed captured via the camera.

19. The method of claim 17, further comprising:
providing a tele-operation component configured to facilitate tele-operation of the vehicle by a tele-operator, wherein the control signal is associated with the tele-operation component; and
receiving, via the tele-operation component and from the ICU, one or more vehicle motion parameters.

20. The method of claim 17, wherein transmitting the control signal comprises transmitting a cellular communication over a private cellular network, the cellular communication including the control signal.
